(19) United States
(12) Patent Application Publication
(10) Pub. No.: US 2012/0055913 A1
(43) Pub. Date: Mar. 8, 2012

(54) VEHICULAR FLUID HEATER

(75) Inventors: Hsuan Yao Huang, Eden Prairie, MN (US); Michael Wright, Wales (GB)

(73) Assignees: KAITEN TECHNOLOGY ELECTRONIC (GUANGZHOU) LTD., Guangzhou, Guangdong Providence (CN); KAUTEX TEXTRON CVS LIMITED, Hengoed, Mid Glamorgan (GB)

(21) Appl. No.: 13/140,923

(22) PCT Filed: Dec. 19, 2008
(86) PCT No.: PCT/EP08/10919

§ 371 Date: Nov. 14, 2011

(51) Int. Cl. B60L 1/02

(52) U.S. Cl. 219/202

(57) ABSTRACT

The invention refers to a vehicular fluid heater (3), in particular to an automotive water heater. The vehicular fluid heater (3) comprises at least one heat exchanger (8) and at least one electrically operated heating unit (9), the heat exchanger (8) comprising at least one thermally conductive body defining at least one fluid channel for the fluid to be heated and sealing covers (16a, 16b) sealing the front and rear ends of the thermally conductive body, at least one cover (16a) having an inlet and/or outlet for establishing fluid flow, the heating unit (9) being joint to a heat-conductive surface of the thermally conductive body. The sealing covers (16a, 16b) are made from a pressure deformable material and are held in position by a housing and closing the fluid heater (FIG. 3).

The application refers to a vehicular fluid heater, in particular to an automotive water heater, comprising at least one heat exchanger and at least one electrically operated heating unit, the heat exchanger comprising at least one thermally conductive body defining at least one fluid channel for the fluid to be heated and sealing covers sealing the front and rear ends of the thermally conductive body, at least one cover having an inlet and/or outlet for establishing fluid flow, the heating unit being joint to a heat conductive surface of the thermally conductive body.

A vehicular fluid heater of the above-referred kind is for instance disclosed in US 2008/0138052 A1. This US patent publication refers to an automotive water heater having application to a windshield of an automobile which is able to produce hot water that can be sprayed onto the windshield of a motor car to melt accumulated snow and frost. The automotive water heater according to the prior art comprises an aluminum heat exchanger defining fluid channels through which water to be heated can flow. Heat conductive surfaces of the heat exchanger are provided with electrically operated heating units. The heating units comprise laminated heating strips joint to plate electrodes. The heating units utilize PTC stones (Ceramic Resistance Members with Positive Temperature Coefficient) as electro-thermal material. The heat exchanger defines flow paths that enable water to flow therethrough. Seal end covers are disposed at a front and a rear end of the flow paths respectively.

Vehicular fluid heaters of the before-mentioned kind are designed to deliver a certain amount of heated screen wash fluid on demand at a pre-programmed target temperature which is normally between 60° C. to 70° C. Heat exchangers according to the prior art are designed as fluid vessels which define fluid channels. The heat exchangers normally contain an amount of 60 to 70 cc of screen wash fluid which is sprayed e.g. onto the windshield of a car once the target temperature has been reached.

It should be clear that such vehicular fluid heater may also be used for other purposes than heating wash fluid for defrosting or cleaning a windshield, a headlamp or the like. Such vehicular fluid heater may also be used to reduce viscosity or to pre-heat oil or to defrost diesel fuel, especially at low ambient temperatures.

Moreover, heated washing fluid may be provided advantageously at normal ambient temperature in order to enhance the cleaning results in a vehicle wash fluid system. It is generally known that warm or heated fluid provides better cleaning efficiency than cold fluid.

A vehicle screen wash device is however generally subject to a wide range of temperatures. It is most likely that screen wash applications are typically used under sub-freezing conditions. In order to prevent a phase change of water to the solid state, normally cleaning fluids do not only contain detergents, but also defrosting agents such as alcohols. It is also known to provide electrical heaters within the fluid reservoir for the washing fluid.

However, it might nevertheless happen that the washing fluid freezes. The growth or expansion of ice in such cases can cause permanent structural damages to all the components of the windshield cleaning installation. The resulting damage may cause leaks, fractures, yield of materials or general malfunction.

This is for instance addressed in U.S. Pat. No. 6,889,005 B2 which discloses a fluid heater apparatus which supplies heat to wash fluid via a flow path in a thermally conductive body. A heat source is disposed in the thermally conductive body for imparting the heat to the body. Fluid in a fluid path in the thermal body enveloping the heat source adsorbs heat from the body. In order to prevent freezing damages, a fluid expansion member is fixed to the mass over the open ends of the fluid flow path in the thermal body. The fluid expansion member is formed of a compressible foam material having shape memory.

It is an object of the present invention to provide a vehicular fluid heater of the above-referred kind with enhanced freeze protection. It is furthermore an object of the invention to utilize the advantageous design of the heat exchanger already disclosed in US 2008/0138052 A1. This and other objects of the present inventions are achieved by a vehicular fluid heater, in particular by an automotive water heater, comprising at least one heat exchanger and at least one electrically operated heating unit, the heat exchanger comprising at least one thermally conductive body defining at least one fluid channel for the fluid to be heated and sealing covers sealing the front and rear ends of the thermally conductive body, at least one cover having an inlet and/or outlet for establishing fluid flow, the heating unit being joint to a heat-conducting surface of the thermally conductive body, the vehicular fluid heater according to the invention being characterized in that the sealing covers are being held in position by a housing enclosing the fluid heater.

The housing itself may have insulating properties so that the housing itself already provides frost protection. Moreover, such design allows the utilization of diaphragm type sealing covers which are held in position by the housing.

In one advantageous embodiment, at least one sealing cover is made from a pressure deformable material such as rubber. The sealing cover may be designed such that the sealing between the fluid chambers and the exterior of the fluid vessel (heat exchanger) will be disabled once a phase change of the cleaning fluid occurs. It is well-known that formation of ice increases the volume by 8 to 10%. A design according to the invention allows to use a diaphragm or membrane as a sealing cover.

In this regard it is particularly advantageous that the sealing covers close the front and rear ends of the heat exchanger which is mainly consisting of a metal body. In the event of sub-freezing conditions, it can be expected that the phase change of the cleaning fluid first happens in the center of the heat exchanger since the metal body of the heat exchanger has an increased thermal conductivity. Freezing will proceed from the inside of the heat exchanger towards the front and rear ends where the sealing covers can vault outwardly.

In another very advantageous embodiment of the vehicular fluid heater according to the invention at least one resilient backing member at least partially supporting at least one sealing cover against the housing upon deformation is provided. This backing member may be employed as additional support during normal operation conditions and to prevent diaphragm fatigue during repeated flexing of the sealing covers. Such resilient backing member can comprise resilient foam and particularly closed cell foam.

The surrounding housing may comprise at least one cavity for receiving one backing member. The flexible sealing covers are designed to flex into the cavity of the housing under freeze conditions. As mentioned before, the cavity or void is filled by a closed cell foam support in order to prevent diaphragm fatigue.

In one embodiment of the invention, the housing comprises several parts engaging each other via snap-fit connectors.

The housing may at least comprise a main body and first and second end caps snap-fitted to the main body, the first end cap being provided with electrical connectors, the second end cap being provided with fluid connectors. The main body of the housing may comprise one compartment for receiving the heat exchanger and another compartment for comprising an electric circuit board.

In the preferred embodiment, the sealing covers establish communication at least between some sections of the fluid channel of the heat exchanger in order to establish a fluid flow in a sequential order. This sealing function is disconnected while the respective sealing cover is being deformed at sub-freeze condition.

In one advantageous embodiment, the fluid connectors are in the form of nippels extending through and sealing the fluid opening in a sealing cover.

In one advantageous embodiment the sealing covers comprise sealing members such as sealing grooves preventing fluid communication at least between some sections of the fluid channel in order to establish a fluid flow in a sequential order, the sealing members are being held in place even under deformation of the sealing cover by the housing 11.

The invention is hereinafter described by way of example with reference to the accompanying drawings in which:

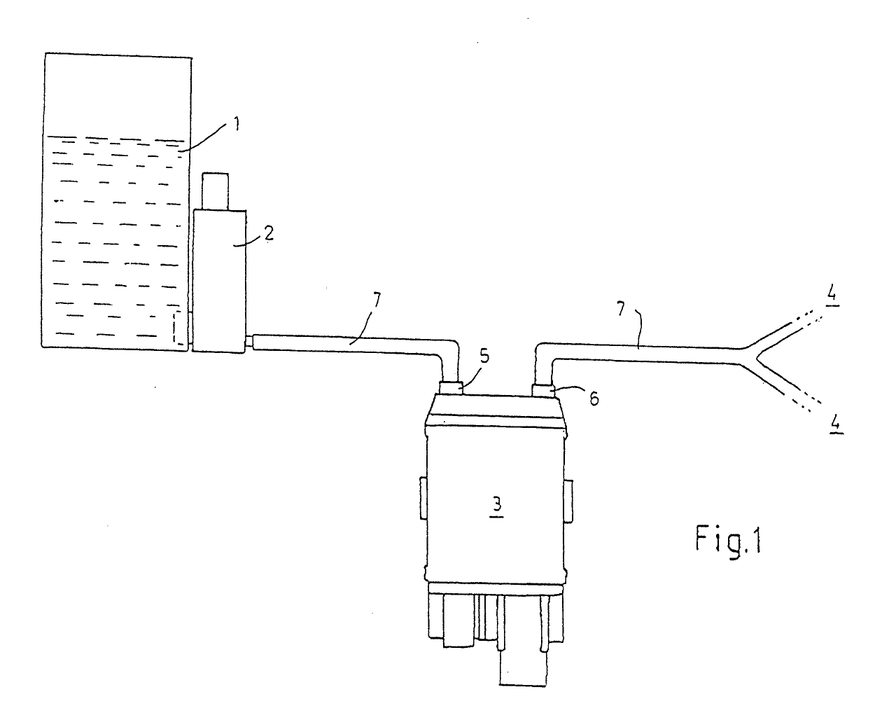

FIG. 1 shows an automotive screen wash device,

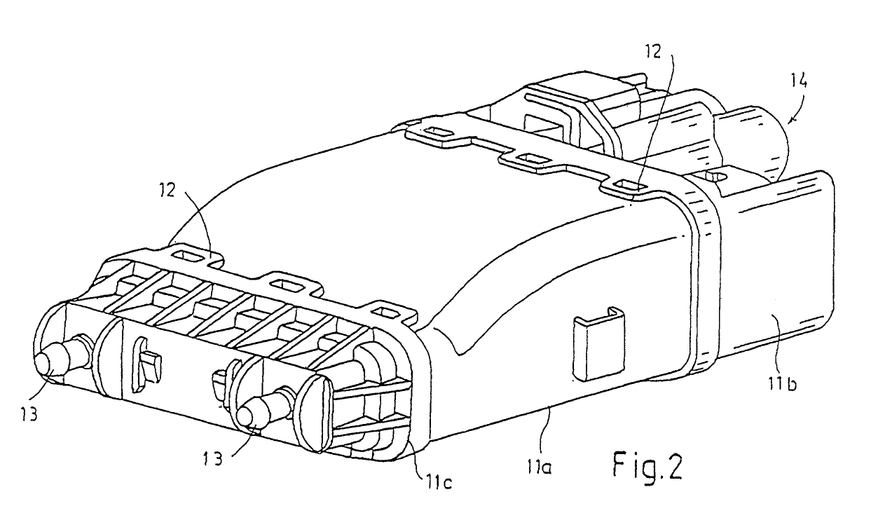

FIG. 2 shows a perspective view of the vehicular fluid heater according to the invention,

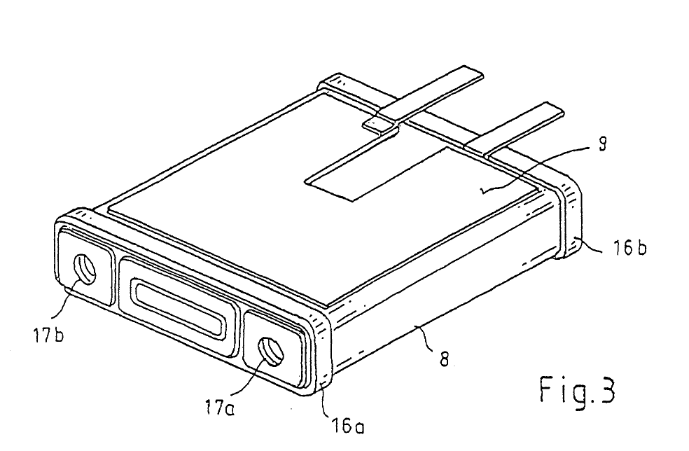

FIG. 3 shows a perspective view of the heat exchanger in sealed position,

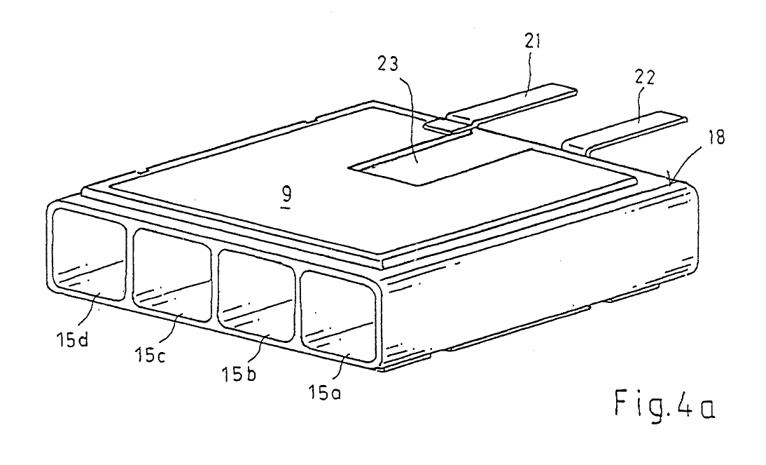

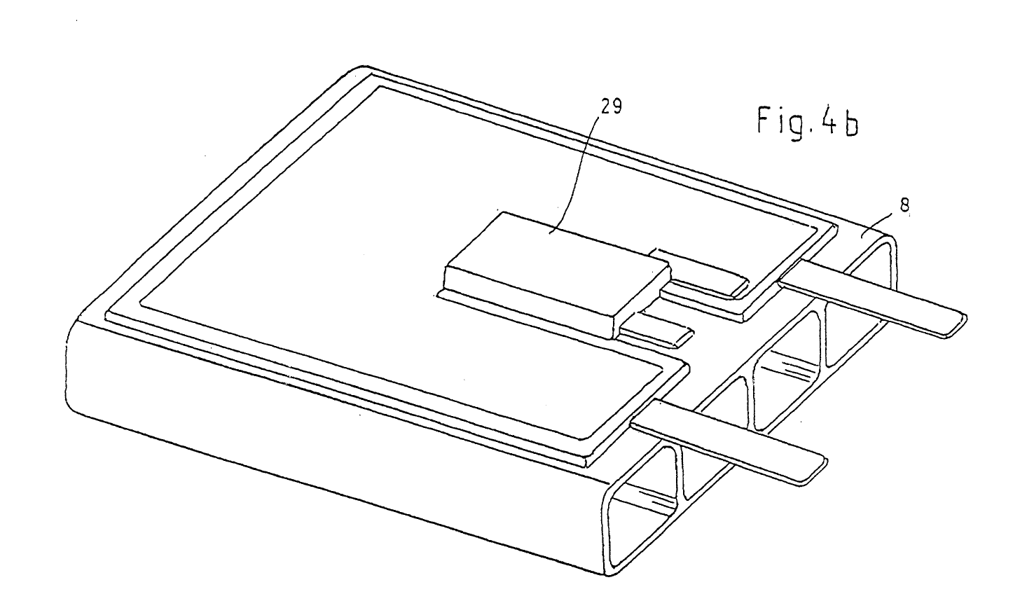

FIG. 4a shows a perspective view of the heat exchanger without the sealing covers,

FIG. 4b shows a perspective view of the heat exchanger according to is another embodiment of the invention,

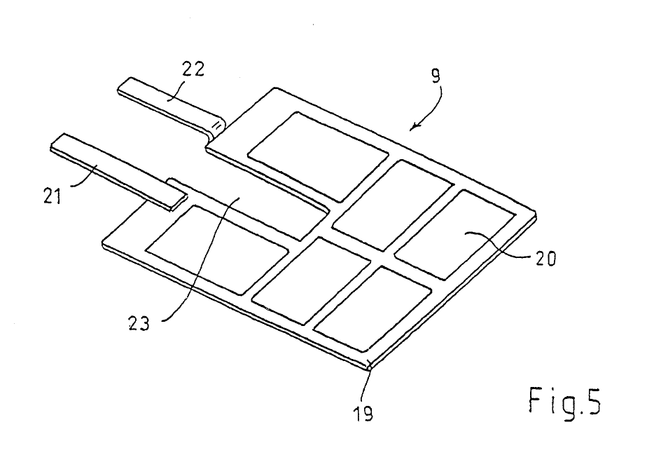

FIG. 5 shows a perspective view of a heating unit,

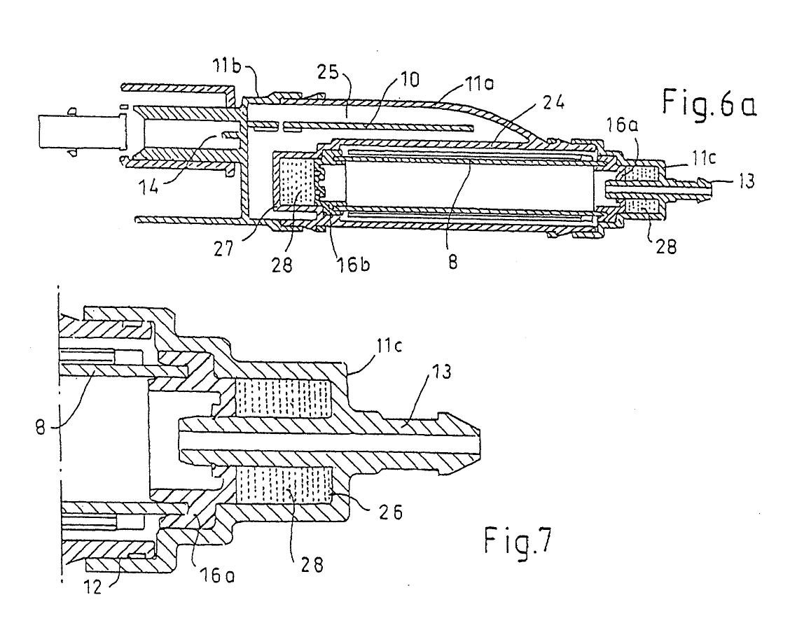

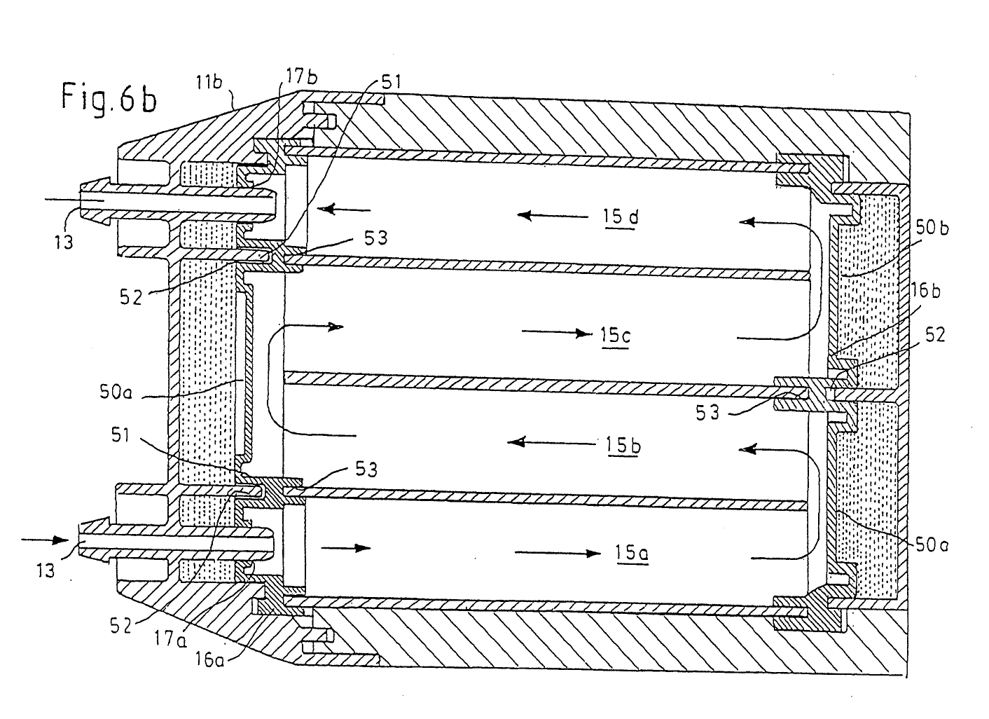

FIG. 6a shows a cross-sectional view through the vehicular fluid heater in the longitudinal direction,

FIG. 6b shows a sectional elevation of the vehicular fluid heater,

FIG. 7 shows an enlarged cross-sectional view of the right hand side of the vehicular fluid heater in FIG. 6,

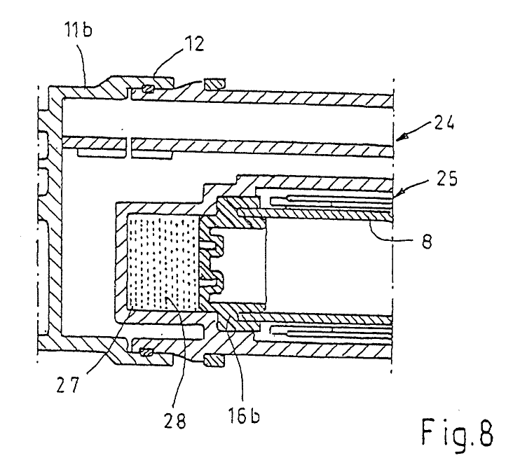

FIG. 8 shows an enlarged cross-sectional view of the left hand side of the vehicular fluid heater as shown in FIG. 6,

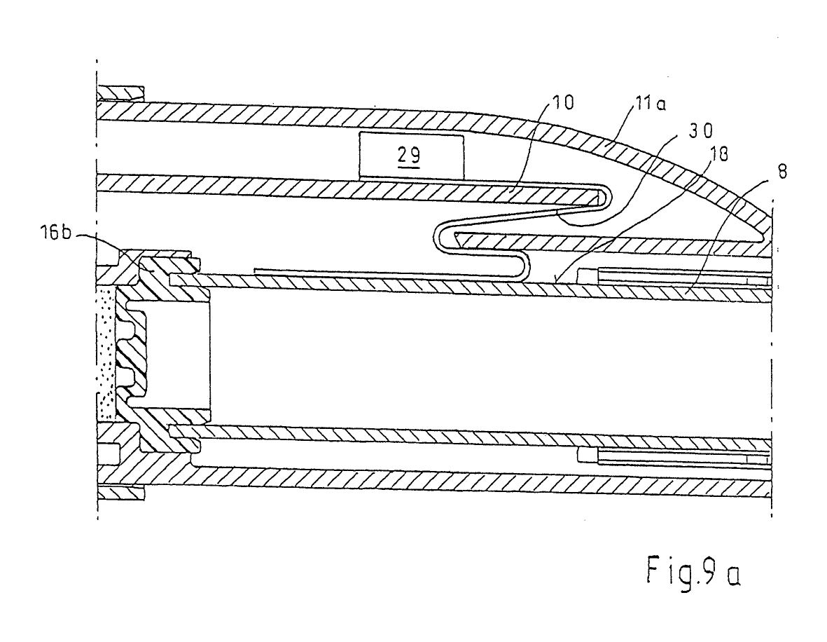

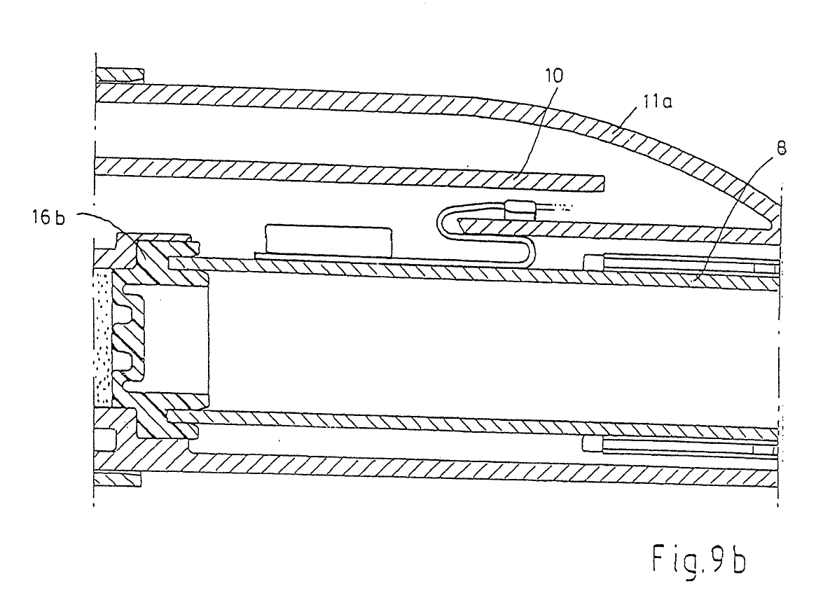

FIG. 9a shows another enlarged cross-sectional view of the vehicular fluid heater showing the connection of the circuit board of the electrical control to the heat exchanger,

FIG. 9b shows another enlarged cross-sectional view of the vehicular fluid heater according to the embodiment shown in FIG. 4b,

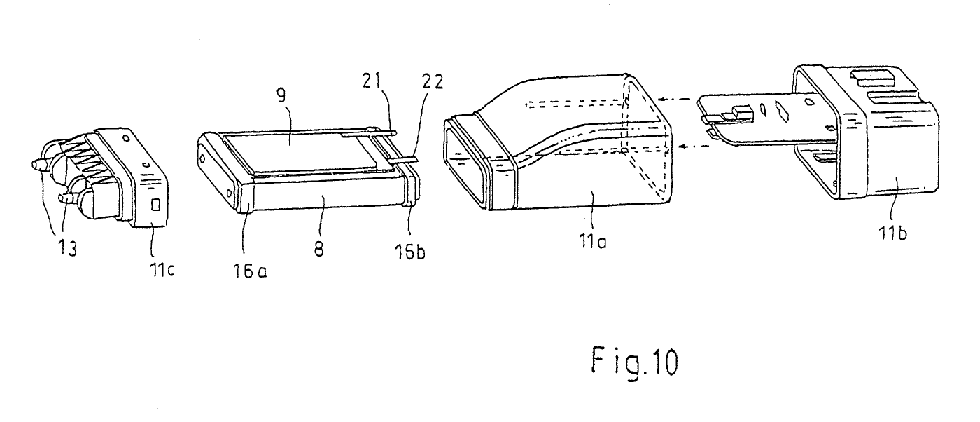

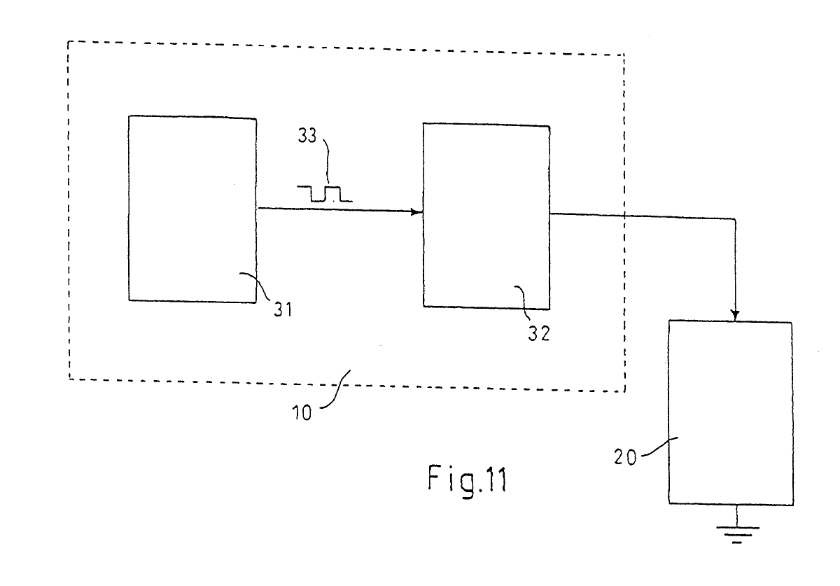

FIG. 10 shows an exploded view of the vehicular fluid heater according to the invention,

FIG. 11 shows a functional diagram of the heating element in combination with a control assembly,

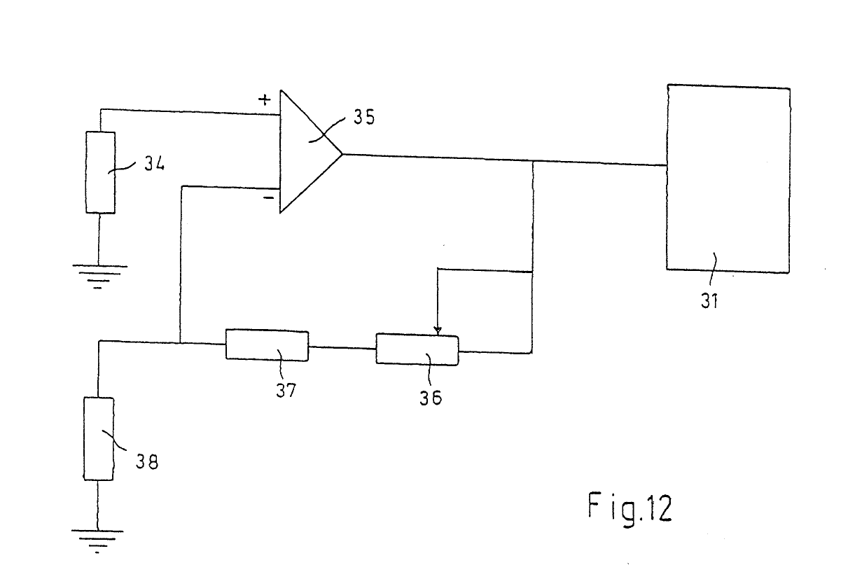

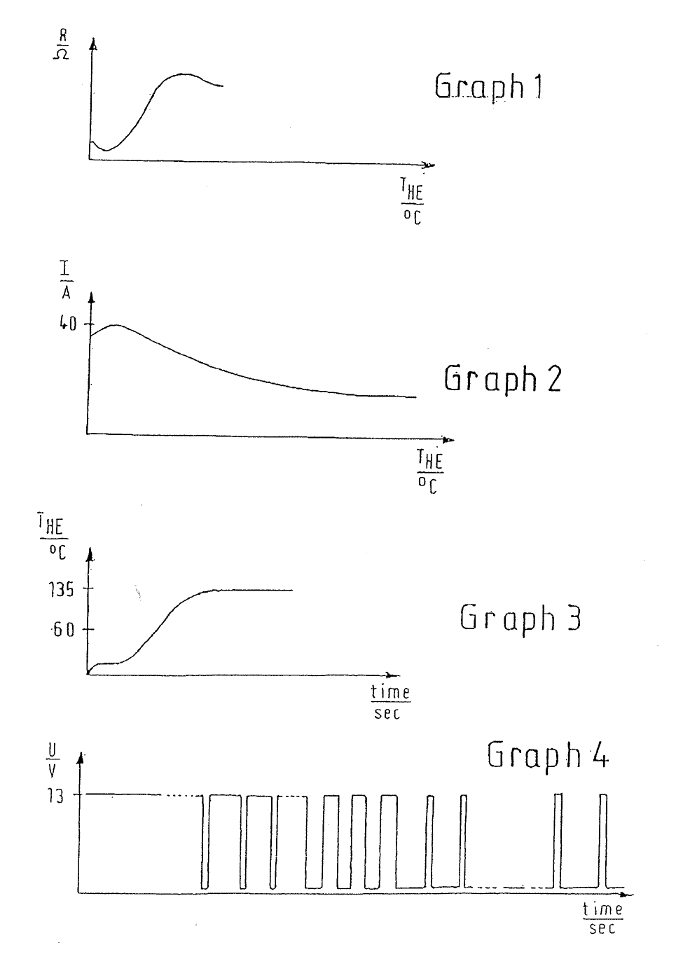

FIG. 12 shows a circuit diagram of a measurement circuitry to measure the voltage at a sampling resistor,

Graph 1 shows the resistance of a PTC stone versus the actual temperature of the PTC stone,

Graph 2 shows the current flowing through a PTC stone versus the actual temperature of the PTC stone for a constant voltage,

Graph 3 shows the actual temperature of the PTC stone versus time in case a voltage is applied to the PTC stone, and

Graph 4 shows an exemplary rectangular shaped control signal.

FIG. 1 shows a schematic view of a windshield screen wash device for a vehicle comprising a washing fluid reservoir 1, a washing fluid pump 2, a vehicular fluid heater 3 and screen wash nozzles 4 associated with a windshield of a car which is not shown. During normal screen wash operation, cleaning fluid is drawn from the cleaning fluid reservoir 1 by an electrically operated pump 2 towards the windshield of a vehicle. It is to be understood that the cleaning fluid can also be delivered to headlamps, rear lamps or other screens to be cleaned. The cleaning fluid enters the vehicular fluid heater 3 via inlet port 5 and will be discharged via outlet port 6. As this can be seen from FIG. 1, the inlet port 5 is connected to the washing fluid pump 2 by a flexible hose 7. In the same way, the outlet port 6 is connected to the washing fluid nozzles 4 by another flexible hose 7. FIG. 1 shows the screen wash device only by way of example and very simplified.

The washing fluid reservoir normally contains washing fluid at ambient temperatures which can be in the order from −40 to 40° C. The vehicular fluid heater 3, as this will be described in detail hereinafter, may contain a fluid volume between 60 and 70 cc. The vehicular fluid heater 3 is designed to deliver heated screen wash fluid on demand at a pre-programmed target temperature of between 50 to 70° C., preferably at a temperature below the evaporation temperature of alcohol which is normally to be found in all winter mixtures of cleaning fluid. On turning the ignition of the vehicle, the vehicular fluid heater is designed to heat up to its target temperature. This can be visualized by an LED in the cabin of the vehicle. Either the user can defrost on demand or the defrost mode may be started automatically. When a defrost switch in the cabin of the vehicle is momentarily depressed, the heater module sends a signal to the wiper control unit which in turn signals the washing fluid pump 2 to dispense a series of heated shots of heated screen wash fluid, typically 4 to 6 shots. The wiper may also be operated at this time to help with the cleaning process. The vehicular fluid heater comprises a heat exchanger 8, electrically operated heating units 9 and an electrical control board 10, all parts enclosed by a common housing 11. The housing 11 comprises three parts, namely a main body 11a, a first end cap 11b and a second end cap 11c. The first and second end caps 11b, c are connected to the main body 11 a via snap-fit connectors 12.

The housing may consist of thermoplastic material and may be for instance made by injection-molding.

As this can be taken in particular from FIG. 2, the second end cap 11c is provided with nippels 13 from which one communicates with the inlet port 5 and the other one communicates with the outlet port 6. The first end cap 11a is provided with terminal connectors 14 which establish the electrical connection of the vehicular fluid heater 3.

As this can be seen from FIGS. 3, 4a and 4b, a central part of the vehicular fluid heater is the heat exchanger 8 which consists of an extruded aluminum profile defining a fluid channel 15 allowing the fluid to flow into the heat exchanger 8 sequentially by help of sealing covers 16a and 16b sealingly closing the front and rear end of the heat exchanger 8.

The side of the heat exchanger 8 shown in FIG. 3 facing the reader for sake of simplicity is in the further description designated the front end, whereas the opposite end of the heat exchanger 8 will be addressed as the rear end. The sealing covers 16 fulfill the sealing function for the front and rear end of the heat exchanger and for sealing the side-by-side sections of the fluid channel 15.

As this can be taken from FIG. 6b, the fluid channel 15a is at the front end of the heat exchanger 8 sealed by sealing cover 16a relative to fluid channel 15b, whereas at the rear end of the heat exchanger 8 the sealing cover 16b establishes fluid connection between fluid channel 15a and fluid channel 15b. Moreover, at the front end of the heat exchanger 8, fluid channel 15b communicates with fluid channel 15c whereas fluid channel 15c is sealed relative to fluid channel 15d.

Furthermore, the sealing cover 16a comprises an inlet opening 17a and an outlet opening 17b.

The sealing covers 16a and 16b are made from an elastically deformable material such as natural or synthetic rubber and function as a kind of diaphragm or membrane in order to compensate the volume change of the cleaning fluid in the frozen state as this has been described before. The sealing covers 16a, b are in the described embodiment loosely fit onto the front and rear ends of the heat exchanger and are held in place by the housing 11, such as it is hereinafter described in more detail.

In order to define a continuously extending fluid channel 15a, 15b, 15c, 15d within the heat exchanger 8 which is made from an extruded aluminum profile, the sealing covers 16a and 16b comprise diaphragm type bridging members 50a and 50b, the sealing cover 16a comprising one bridging member 50a connecting the fluid channels 15b and 15c with each other, whereas sealing cover 16b comprises two bridging members 50b, one connecting the fluid channels 15a and 15b, the other one connecting the fluid channels 15c and 15d. Each of the diaphragm type bridging members 50a, 50b is surrounded by a circumferential sealing rim 51.

As this can be seen in more detail from FIG. 6b in cross section the sealing rim 51 defines an outer groove 52 and an inner groove 53. The inner groove 53 sealingly receives the peripheral walls of the fluid channels 15a, 15b, 15c and 15d, whereas the outer groove 52 receives locating webs 54 of the first and second end caps 11b and 11c of the main body 11a when mounted. In the event the bridging members 50a and 50b should flex due to freezing cleaning fluid, the sealing rim 51 is properly held in place by the locating webs 54 of the end caps 11b and 11c, thus allowing fluid expansion/contraction without significantly effecting the sealing function of the sealing covers 16a and 16b.

As mentioned before, the heat exchanger 8 is made from a thermally conductive material such as aluminum. At the side surfaces of the heat exchanger 8, heating units 9 are provided. The electrically operating heating units 9 are adhered to the heat exchanger by a heat curable silicon glue. Those heating units 9 utilize a laminated structure. Although in a preferred embodiment the heating units 8 utilize a ceramic resistor with a positive temperature coefficient of resistivity (PTCR), it is to be understood that the heating units 9 can be in form of heating strips with a polymer-resistant material with thermal electrical properties or an heating wire, encapsulated or not, having thermal-electrical properties.

In one preferred embodiment, the heating unit (FIG. 5) comprises a laminated frame 19 supporting ceramic elements 20, a cathode contact plate 21 and an anode contact plate 22 insulated relative to the cathode contact plate 21.

Within the frame 19 there is a void 23 the function of which will be explained later.

The heating unit 9 comprises one or more positive temperature coefficient ceramic resistor heating elements 20, afterwards referred to as PTC stones 20, the cathode contact plate 21 and the anode contact plate 22 for conduction of electricity, for example 13 V, to the PTC stones 20. The anode contact plate 22/anode terminal is in direct contact with the heat exchanger 8 and the contact plate portion covers the anode sides of the PTC stones 20 which is fixed in position by the position frame 19. The cathode terminal/contact plate 21 is on top of the cathode sides of the PTC stones 20 thereby parallel connecting all PTC stones 20.

Due to this design the heat exchanger 8 is connected to ground (GND) so that any static charge build up in the fluid may be deflected.

PTC stones 20 are semi-conductors having conductivity inversely proportional to their overall temperature. Thus, while the heating unit 9 is cold, the conductivity of the PTC stones 20 is high, and high current will flow through the PTC stones 20; thereby generating a great amount of thermal energy. On the other hand, if PTC stones 20 rise in temperature the conductivity of the PTC stones 20 drop dramatically resulting in the generation of only a small amount of heat. As a result, since a PTC stone 20 is capable of maintaining its own target temperature (thermally self-regulating), a heating unit 9 using PTC stones 20 as heating elements does not require protection by thermostats or thermofuses. PTC stones 20 are available with different target temperatures, for example 65° C. or 135° C.

Graph 1 shows the resistance (R) of the PTC stone 20 versus the actual temperature (T_{HE}) of the PTC stone 20. As mentioned above, in case the PTC stone 20 is cold, its resistance (R) is low. The resulting high current flowing through the PTC stone 20 generates a great amount of thermal energy which heats up the PTC stone 20. As can be seen from graph 1, the resistance (R) of the PTC stone 20 increases with an increase of its actual temperature (T_{HE}). In case the actual temperature (T_{HE}) of the PTC stone 20 equals the maximum temperature, the resistance (R) of the PTC stone 20 starts to decrease in accordance to a decrease in the actual temperature (T_{HE}) of the PTC stone 20. This results in a higher current through the PTC stone 20 which again heats up the PTC stone 20, resulting in an increase of the resistance (R) of PTC stone 20. Correspondingly, as shown in graph 2, the current (I) flowing through the PTC stone 20 decreases with an increase of its actual temperature (T_{HE}). Hence, less thermal energy is generated. Using this mechanism, the PTC stone 20 limits its maximum temperature to a specific target temperature.

In a heating application the PTC stone 20 can reach an equilibrium state where the current consumption is equal to the thermal dissipation rate of the PTC stone 20 in a constant ambient condition.

PTC stones 20 will adopt their current consumption to reach an equilibrium state with the ambient condition, e.g. a greater thermal dissipation (cooling)will lead to a higher current consumption of the PTC stones 20 in the equilibrium state. Once power is applied to the PTC stones 20 they immediately try to reach their target temperature. In the beginning the temperature increases rapidly, but with an increase of the actual temperature (T_{HE}) of the PTC stone 20, the increase rate slows down. This relationship between the actual temperature (T_{HE}) of the PTC stone 20 and the time is shown in graph 3.

In one preferred embodiment the heating unit 9 is designed to heat up the screen wash fluid to a target temperature of for example 65° C. This could be accomplished by using PTC stones 20 with a target temperature of 65° C. This would require a relatively long time needed to heat up the PTC stones 20 to their target temperature and hence to heat up the screen wash fluid to this target temperature. The heated screen wash fluid is used to remove the accumulated snow/frost and to improve the cleaning effectiveness during warmer seasons.

According to another embodiment, PTC stones 20 with a target temperature of 135° C. are used to shorten the time needed to heat up the PTC stones 20. This shortens the time needed to heat up the PTC stones 20 to the target temperature of 65° C. because the PTC stones 20 operate in the range where the increase rate of the temperature is high. A functional diagram of a PTC stone 20 with an control assembly 10 is shown in FIG. 11.

The control assembly 10 comprises a control unit 31 and a switching unit 32. In a first step the actual resistance of the PTC stone 20 is measured. This can be accomplished by a resistance measurement of the PTC stone 20 or a voltage/current measurement at a sampling resistor 34, as will be explained later. The control unit 31, preferably a microprocessor, maps the result of this measurement to an actual temperature of the PTC stone 20 by means of a comparison chart or an algorithm. The actual temperature of the PTC stone 20 afterwards will be compared to an adjustable target temperature, which in this embodiment is 65° C. In the next step, the control unit 31 produces a control signal 33 with an adjustable pulsewidth. The pulsewidth of the control signal 33 depends on the actual temperature of the PTC stone 20. The control signal 33 controls the switching unit 32 which controls the conductivity of electricity to the PTC stone 20. In this embodiment the switching unit 32 consists of a MOSFET. During the on cycle of the control signal 33 the switching unit 33 supplies power to PTC stone 20, so that the PTC stone 20 further heats up. During the off cycle of the control signal 33 no power is supplied to the PTC stone 20 by the switching unit 32. Hence, the PTC stone 20 does not further heat up. The control unit 31 reduces the on cycle of the control signal 33 in case the temperature of the PTC stone 20 rises. Using this mechanism, the actual temperature of the PTC stone 20 is limited to for example 65° C.

Graph 4 shows an exemplary control signal 33 with an adjustable pulsewidth. As can be seen, the control signal 33 consists of retangular impulses. In the beginning, during the initial heating of the PTC stone 20, the control signal 33 only consists of an on cycle and no off cycle. As the PTC stone 20 reaches the adjustable target temperature of 65° C., the control unit 31 reduces the pulsewidth of the control signal 33 in order to lower the heating of the PTC stone 20. In the event the PTC stone 20 exceeds the adjustable temperature of 65° C., the control unit 20 produces a control signal 33 only consisting of an off cycle, so that the PTC stone 20 is not further heated up. In case the temperature of the PTC stone 20 drops below 65° C., the control unit 31 again increases the pulsewidth of the control signal 33 to heat up the PTC stone 20.

As mentioned above, in a first step the actual resistance of the PTC stone 20 is measured. This can be accomplished by means of a voltage measurement at a sampling resistor 34 which in this embodiment has a resistance of 13 mΩ (see FIG. 12). This sampling resistor 34 is connected into series with the PTC stone 20. As the input voltage to the serial connection of PTC stone 20 and sampling resistor 34 is fixed, the voltage drop at the sampling resistor 34 is directly proportional to the resistance of the PTC stone 20. The voltage drop at the sampling resistor 34 is amplified by operational amplifier 35. As known by a person skilled in the art, the rate of amplification is defined by resistors 36, 37, 38. The measured and amplified voltage drop at sampling resistor 35 is passed to the control unit 31. The control unit 31 maps this amplified voltage drop at sampling to resistor 35 to an actual temperature of the PTC stone 20 by means of a comparison chart or an algorithm.

With reference to FIG. 6a, it can be seen that the housing 11 has a heat exchanger compartment 24 and a control board compartment 25, the control board 10 as well as the heat exchanger 8 being completely encapsulated by the housing 11. The heat exchanger compartment 25 of the housing 11 thereby defining a front cavity 26 and a rear cavity 27 in which the elastically deformable sealing covers 16a, 16b which are loosely fitted to the heat exchanger 8 may flex upon phase change of the washing fluid which might happen for instance when the defrosting agent concentration within the cleaning fluid is not high enough.

It is to be understood that, due to the diaphragm type properties of the sealing covers 16a, b, optimal freeze protection is guaranteed.

As this can be seen from FIGS. 7 and 8, the sealing covers 16a and 16b abut against the housing 11 such that the sealing covers 16a and 16b are held in place by the housing 11.

As an alternative solution, the sealing covers 16a, 16b may be glued or otherwise adhered to the heat exchanger 8. In this event it is not necessary to provide a housing.

As this can be seen from FIGS. 6a and 6b, the rearwardly facing sealing cover 16b abuts against a part of the housing within the heat exchanger compartment 24 whereas the sealing cover 16a at the front end of the heat exchanger abuts against the second end cap 11c of the housing 11. Within the front end rear cavities 26 and 27 a foam-backing member 28 is arranged. This foam-backing members 28 are made of a resilient closed cell foam.

As also can be seen from FIG. 6a, the first end cap comprises thermal connectors 14 for the electrical connection of the vehicular fluid heater.

Electrical power is supplied via a MOSFET (Metal Oxide Semiconductor Field Effect Transistor) 29 arranged on the control board 10. Moreover, on the control board a microcontroller not designated by any reference numeral is arranged.

Utilization of a MOSFET 29 has been proven to be advantageous for the power control of the ceramic elements 20.

According to the invention, the heat dissipated by the MOSFET 29 during operation is conducted to the exterior surface of the heat exchanger. In one embodiment (FIG. 9a) the heat dissipated by the MOSFET 29 during operation is conducted via heat sink to the exterior surface of the heat exchanger. The heat sink in the embodiment according to FIG. 9a is designed as a resilient conductive metal strip 30. The metal strip 30 can for instance be made of copper or another thermally conductive material. The metal strip 30 is directly adhered to one side face 18 of the heat exchanger 8. For this purpose, a void 23 is provided in one frame 19 of one heating unit 9.

In the embodiment shown in FIGS. 4b and 9b the MOSFET 29 is directly attached to the heat exchanger 8 so that the heat dissipated by the MOSFET 29 will be directly transferred into the heat exchanger and/or into the heating unit and thus utilized for heating the cleaning fluid. The MOSFET 29 is preferably electrically insolated on the conductive body of the heat exchanger 8, for instance by an intermediate layer with high dielectric values (for instance AL₂O₃) between the MOSFET 29 and the heat exchanger 8. MOSFET 29 may be joined to the PTC as well. Electrical connection to the circuit board 10 may be established by terminal connector 55.

### REFERENCE NUMERALS

1 Washing fluid reservoir

2 Washing fluid pump

3 Vehicular fluid heater

4 Nozzles

5 Inlet port

6 Outlet port

7 Hose

8 Heat exchanger

9 Heating unit

10 Control board

11 Housing

11a Main body

11b First end cap

11c Second end cap

12 Snap-fit connectors

13 Nippels

14 Terminal connectors

15, 15a,b,c,d Fluid channel

16a, b Sealing cover

17a Inlet opening

17b Outlet opening

18 Side faces

19 Frame

20 Ceramic elements

21 Cathode contact plate

22 Anode contact plate

23 Void

24 Heat exchanger compartment

25 Control board compartment

26 Front cavity

27 Rear cavity

28 Backing members

29 MOSFET

30 Metal strip

31 Control unit

32 Switching unit

33 Control signal

34 Sampling resistor

35 Operational amplifier

36 Resistor

37 Resistor

38 Resistor

50a, 50b Bridging member

51 Sealing rim

52 Outer groove

53 Inner groove

54 Locating webs

55 Terminal connectors

1. A vehicular fluid heater, in particular an automotive water heater, comprising at least one heat exchanger and at least one electrically operated heating unit, the heat exchanger comprising at least one thermally conductive body defining at least one fluid channel for the fluid to be heated and sealing covers sealing the front and rear ends of the thermally conductive body, at least one cover having an inlet and/or outlet for establishing fluid flow, characterized in that the sealing covers are being held in position by a housing and are closing the fluid heater.

2. A vehicular fluid heater according to claim 1, characterized in that at least one sealing cover is made from a pressure deformable material such as rubber.

3. A vehicular fluid heater according to claim 1, characterized by at least one resilient backing member at least partially supporting at least one sealing cover against the housing at least upon deformation.

4. A vehicular fluid heater according to claim 3, characterized in that the backing member comprises a resilient foam, in particular closed cell foam.

5. A vehicular fluid heater according to claim 3, characterized in that the housing comprises at least one cavity for receiving one backing member.

6. A vehicular fluid heater according to claim 1, characterized in that the housing comprises several parts engaging each other via snap-fit connectors.

7. A vehicular fluid heater according to claim 1, characterized in that the housing comprises at least a main body and first and second end caps snap-fitted to the main body, the first end cap being provided with electrical connectors, the second end cap being provided with fluid connectors.

8. A vehicular fluid heater according to claim 1, characterized in that the sealing covers establish fluid communication at least between some sections of the fluid channel of the heat exchanger in order to establish a fluid flow in a sequential order.

9. A vehicular fluid heater according to claim 7, characterized in that the fluid connectors are in the form of nippels extending through and sealingly engaging fluid openings in a sealing cover.

10. A vehicular fluid heater according to claim 1, characterized in that the sealing covers comprise sealing members, such as sealing grooves preventing fluid communication at least between some sections of the fluid channel in order to establish a fluid flow in a sequential order, the sealing members are being held in place even under deformation of the sealing covers preferably by the housing.
